(19) United States
(12) Patent Application Publication
(10) Pub. No.: US 2015/0305519 A1
(43) Pub. Date: Oct. 29, 2015

(54) Advertising Hanger Apparatuses, Systems, and Methods

(71) Applicant: Josef Brahar, Antioch, IL (US)

(72) Inventor: Josef Brahar, Antioch, IL (US)

(21) Appl. No.: 14/699,590

(22) Filed: Apr. 29, 2015

Related U.S. Application Data
(60) Provisional application No. 61/985,533, filed on Apr. 29, 2014.

(51) Int. Cl. A47F 5/08; F16M 13/02; B25J 1/04; G09F 7/18; A47F 5/00

(52) U.S. Cl. CPC A47F 5/0876; G09F 7/18; A47F 5/0006; A47F 5/0892; B25J 1/04; F16M 13/02; G09F 2007/1856

(57) ABSTRACT

The present invention relates to hanger apparatuses, systems, and methods for advertising goods, performance of services, the sale of goods and/or services, and the like. Specifically, the present invention relates to a bracket that hangs from an overhead or near overhead location. The bracket may allow objects to hang from or be otherwise disposed on the hanger to take advantage of empty overhead or near overhead locations

The present invention claims priority to U.S. Prov. Pat. App. No. 61/985,533, titled “Advertising Hanger Apparatuses, Systems and Methods,” filed Apr. 29, 2014, which is expressly incorporated herein by reference in its entirety.

### TECHNICAL FIELD

The present invention relates to hanger apparatuses, systems, and methods for advertising goods, performance of services, the sale of goods and/or services, and the like. Specifically, the present invention relates to a bracket that hangs from an overhead or near overhead location. The bracket may allow objects to hang from or be otherwise disposed on the hanger to take advantage of empty overhead or near overhead locations.

### BACKGROUND

It is, of course, generally known to display goods, signs, advertisements, and other moveable objects. Commonly, advertisements are permanent or semi-permanent in nature. Advertisements may be billboards on the sides of roadways, large signs indicating businesses or service providers, boards or signs on windows, buses, cars, trains, boats, and planes, etc.

For permanent and semi-permanent advertisements, large structures supporting the advertisements are required. Billboard advertisements require large metal support beams. Businesses sometimes require metal framework to connect a large sign to the business' building. Not only are these structures required, but they take up huge areas of space and often cause what is known as visual pollution. Visual pollution disturbs the visual areas of people by creating negative changes in the natural environment. Installing new and additional structures to support billboard advertisements, building signs, and the like only increases visual pollution. Placing advertisements on windows, vehicles, or walls takes advantage of existing space and limits the increase of visual pollution. A need exists for apparatuses, systems, and methods that provide for advertising on existing structures.

Often, however, advertisements are temporary like paper pamphlets, posters, canvas signs, newspapers, plastic boards or signs, etc. While these advertisements do not require large structures to support them, some sort of securing is required, such as using adhesive, tape, nails, screws, rope, hooks, and the like. Commonly, while some advertisements may be temporary in nature, the advertisements must remain in place for a period of time to be effective. Improperly or poorly secured advertisements, both permanent and temporary, may fall, blow away or otherwise become ineffective. A need exists for apparatuses, systems, and methods that properly secure advertisements or goods thereon.

Frequently, whether an advertisement or good is to be displayed permanently or temporarily, installing the advertisement requires an investment of time and effort. In the case of permanent or semi-permanent advertisements, large structures must be built to support the advertisements or goods. If the large structure is already built, a person has to climb the large structure, bring any advertising material up the structure with them, remove any old advertisements or goods, and display new advertisements or goods. This can be dangerous when the large structures are very high above the ground. A need exists for safe apparatuses, systems, and methods for attaching advertisements to structures.

In the case of temporary advertisements like banners or signs, equipment such as ladders, scaffolding, ropes, or the like are used to attach or otherwise secure the advertisements in high places. Often, a person must climb the ladder, scaffolding, rope, or the like to secure a first portion of an advertisement, climb down, shift the ladder, scaffolding, rope, or the like to another area, and climb up the ladder, scaffolding, rope, or the like to secure a second portion of the advertisement. This can be time-consuming and difficult to accomplish if one is working by his or herself. A need exists for apparatuses, systems, and methods for simple and quick application of advertisements and goods.

Moreover, oftentimes using ladders to set or adjust advertisement banners or signs may be unsafe. Specifically, advertisement banners or signs may be a significant distance from the ground, and using a ladder may require an individual to climb the ladder to set or adjust the same. Sometimes ladders are difficult to set properly to reach an inconveniently placed banner or sign. Individuals may fall off ladders, or the ladders themselves may fall if not properly set, causing injury and damage. A need, therefore, exists for apparatuses, systems and methods for setting and/or adjusting banners or signs that is safer than heretofore known.

Additionally, when applying a large advertisement banner or sign by attaching one portion first and another portion second, it is often hard to keep the advertisement banner or sign level. Regularly, after the advertisement is secured to a location, a person may find that the advertisement is not level and may have to start the advertisement application process all over again. A need exists for apparatuses, systems, and methods for leveling advertisements and/or goods.

Frequently, advertisements and goods require a backdrop for the advertisements and goods to be placed thereon. Often, walls, windows, boards, doors, or the like are used to hang advertisements thereon. Empty overhead space is a prime location for advertising or displaying goods, but it is difficult to advertise or display goods in the empty overhead space because there is no backdrop to secure the advertisements or goods thereto. A need exists for apparatuses, systems, and methods that simulate a backdrop for attaching advertisements and/or goods thereon.

### SUMMARY OF THE INVENTION

The present invention relates to hanger apparatuses, systems, and methods for advertising goods, performance of services, the sale of goods and/or services, and the like. Specifically, the present invention relates to a bracket that hangs from an overhead or near overhead location. The bracket may allow objects to hang from or be otherwise disposed on the hanger to take advantage of empty overhead or near overhead locations.

To this end, in an embodiment of the present invention, an apparatus is provided. The apparatus comprises a level extension with at least one securing device disposed thereon, wherein the at least one securing device is capable of being hung at a near overhead location, and at least one attaching device disposed on the level extension, wherein the at least one attaching device is capable of receiving objects to be hung thereon.

In an embodiment, a system is provided. The system comprises a extension, at least one securing device disposable on the extension, wherein the at least one securing device is capable of being hung at a near overhead location, at least one attaching device disposable on the extension, wherein the at least one attaching device is capable of receiving objects to be hung thereon, and a lifting pole, wherein the lifting pole is used to hang the extension at a near overhead location.

In an embodiment, a method is provided. The method comprises the steps of providing an apparatus comprising a level extension with at least one securing device disposed thereon, hanging the at least one securing device over an object, positioning at least one attaching device on the level extension, and hanging an advertisement or good on the at least one attaching device.

It is, therefore, an advantage and objective of the present invention to provide apparatuses, systems, and methods that provide for advertising on existing structures.

It is an advantage and objective of the present invention to provide apparatuses, systems, and methods that properly secure advertisements or goods thereon.

It is an advantage and objective of the present invention to provide safe apparatuses, systems, and methods for attaching advertisements to structures.

It is an advantage and objective of the present invention to provide apparatuses, systems, and methods for simple and quick application of advertisements and goods.

It is an advantage and objective of the present invention to provide apparatuses, systems, and for setting and/or adjusting banners or signs that is safer than heretofore known.

It is an advantage and objective of the present invention to provide apparatuses, systems, and methods for leveling advertisements and/or goods.

It is an advantage and objective of the present invention to apparatuses, systems, and methods that simulate a backdrop for attaching advertisements and/or goods thereon.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a perspective view of a hanger apparatus in a preferred embodiment of the present invention.

FIG. 2 illustrates a front view of an alternate embodiment of the hanger apparatus.

FIG. 3 illustrates a front view of the hanger apparatus from FIG. 2 holding an advertisement in an embodiment of the present invention.

FIG. 4 illustrates a front view of an alternate embodiment of the present invention holding an advertisement with string.

FIG. 5 illustrates a perspective view of a lifting pole for placing a hanger apparatus in a location in an embodiment of the present invention.

FIG. 6 illustrates a front view of a rotatable lifting pole in another embodiment of the present invention.

FIG. 7 illustrates a top view of a lifting pole with high friction material therein in an embodiment of the present invention.

### DETAILED DESCRIPTION OF THE PRESENTLY PREFERRED EMBODIMENTS

The present invention relates to hanger apparatuses, systems, and methods for advertising goods, performance of services, the sale of goods and/or services, and the like. Specifically, the present invention relates to a bracket that hangs from an overhead or near overhead location. The bracket may allow objects to hang from or be otherwise disposed on the hanger to take advantage of empty overhead or near overhead locations.

In a preferred embodiment, the present invention may provide apparatuses, systems, methods and the like for hanging advertisements or goods in overhead locations. The present invention may reduce labor by eliminating a need for large structures or backdrops for advertisements, ladders, and readjustments of the advertisements or goods.

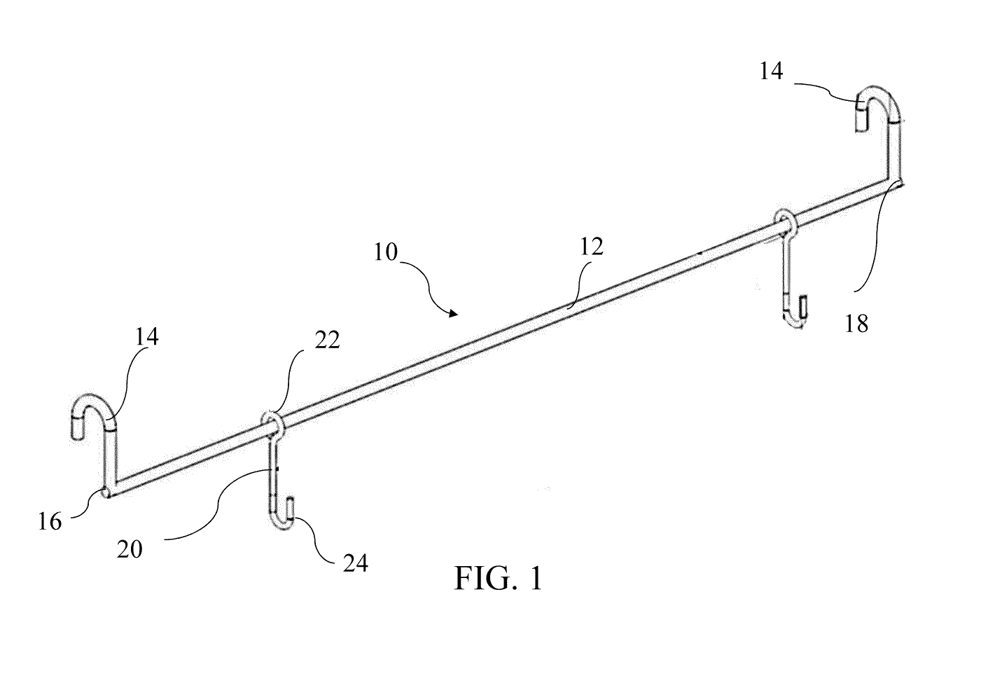

Now referring to the figures, wherein like numerals refer to like parts, FIG. 1 illustrates a hanger apparatus 10. The hanger apparatus 10 may be made from any rigid material, but may preferably be made of rubber, metal, wood, plastic, or any combination thereof The hanger apparatus 10 may have an extension 12. The extension 12 may be sized to a particular advertisement or may be maximally sized in order to cater to numerous advertisement sizes. The extension 12 may be cylindrical, as shown in FIG. 1, but of course may be a rectangular, triangular, or polygonal prism, or other shape known to one skilled in the art. Additionally, the extension 12 may be long and horizontal so that attached advertisements are level. Alternatively, the extension 12 may be any shape that to fit the shape of a particular advertisement or good. For example, the extension 12 may be a semi-circle designed to hold or otherwise support a circular advertisement or good thereunder.

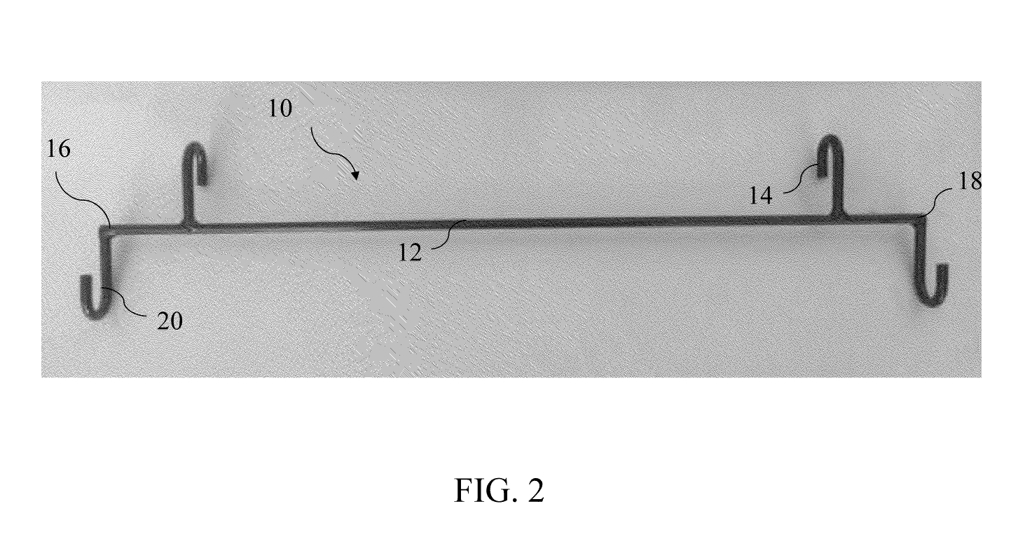

The hanger apparatus 10 may have one or more securing devices 14 disposed on the extension 12. The securing devices may be part of the extension 12 as shown in FIG. 1, but also may be attachable and detachable. Preferably, a securing device 14 may be disposed on a first end 16 of the extension 12 and a securing device 14 may be disposed on a second end 18 of the extension 12. The one or more securing devices 14 may be disposed on the same plane as each other such that the hanger apparatus 10 may be level. Alternatively, the one or more securing devices 14 can be disposed anywhere on the extension 12 from the first end 16 to the second end 18. FIG. 2 illustrates that the one or more securing devices 14 may be placed a length inwardly away from the first end 16 and the second end 18 in one embodiment. In another embodiment, one securing device 14 may be disposed in the middle of the extension 12. The extension 12 may be weighted accordingly so that the hanger apparatus 10 is level even when only one securing device 14 is used.

The one or more securing devices 14 may be arcuate as presented in FIG. 1, but may be of any shape such as flat, squared, triangular, polygonal, or other shape known to one skilled in the art. The one or more securing devices 14 may have an open end so that the hanger apparatus 10 may be hooked around an object. In one embodiment, the hanger apparatus 10 is held in place by gravity. Alternatively, the one or more securing devices 14 may have a latch, to enclose the one or more securing devices 14 around an object to prevent the same from becoming unhooked. The one or more securing devices 14 may be made from the same material as the extension 12. In another embodiment, the one or more securing devices 14 may be surrounded with gel, rubber, foam, or other high friction material to better hold or otherwise support the hanger apparatus 10 in place. Alternatively, the one or more securing devices 14 may be placed on a surface instead of being hung over an object. In an embodiment, the hanger apparatus 10 may be used to display advertisements or goods above the hanger apparatus 10.

Additionally, the hanger apparatus 10 may further comprise one or more attaching devices 20. The one or more attaching devices 20 may have a cross section shape similar to the cross section shape of the extension 12 on a first end 22 of the one or more attaching devices 20 so that the one or more attaching devices 20 may be disposed around the extension 12. Specifically, the first end 22 of the one or more attaching devices 20 may have a hole that may allow the extension 12 and the one or more securing devices 14 to pass therethrough. The first end 22 of the one or more attaching devices 20 may be closed and may completely surround the extension 12 as shown in FIG. 1. In another embodiment, the first end 22 of the one or more attaching devices 20 may be open and may partially surround the extension 12.

The one or more attaching devices 20 may move freely along the extension 12 so that multiple goods, multiple advertisements, or multiple sizes of advertisements or goods may be supported therefrom. The one or more attaching devices 20 may be made from the same material as the extension 12 and the one or more securing devices 14. Additionally, the one or more attaching devices 20 may be surrounded with gel, rubber, foam, or other high friction material to better hold or otherwise support the one or more attaching devices 20 and/or the advertisement or good in place.

In another embodiment, as shown in FIG. 2, one or more attaching devices 40 may be attached to an extension 32 on a first end 36 and a second end 38. Of course the present invention may be rotated and a user may use the one or more securing devices 14 to hold an advertisement or good instead of using the one or more securing devices 14 to hang the present invention from an object. Additionally, a user may use the one or more attaching devices 20 to hang the present invention from an object instead of using the one or more attaching devices 20 to hold an advertisement or good. Using this technique, a user may be able to use one embodiment of the present invention on advertisements or goods of differing sizes, even when the one or more attaching devices 20 and one or more securing devices 14 are attached to the extension 12 like in FIG. 2.

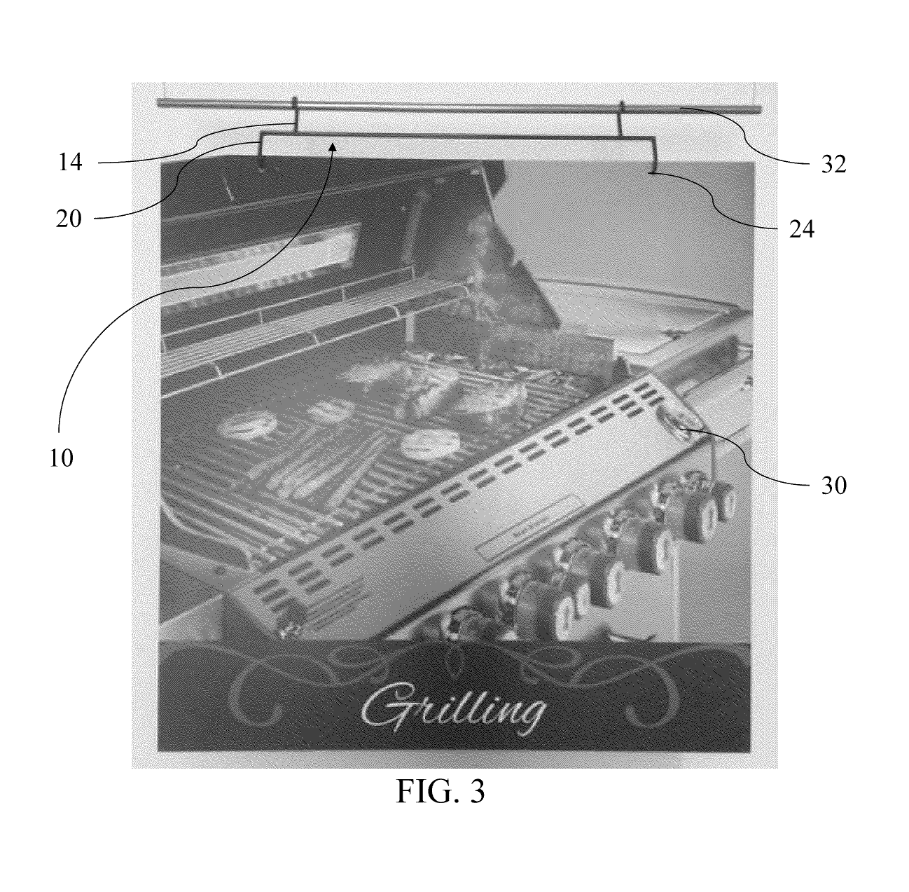

The one or more attaching devices 20 may have a second end 24. The second end 24 of the one or more attaching devices 20 may allow an advertisement or good 30 to be hung or otherwise supported therefrom as shown in FIG. 3. As further shown in FIG. 3, the one or more securing devices 14 may hook around an object 32 to support the hanging apparatus 10 and the advertisement or good 30. In an alternative embodiment, the second end 24 of the one or more attaching devices 20 may hold or otherwise support the advertisement or good 30 above the hanger apparatus 10.

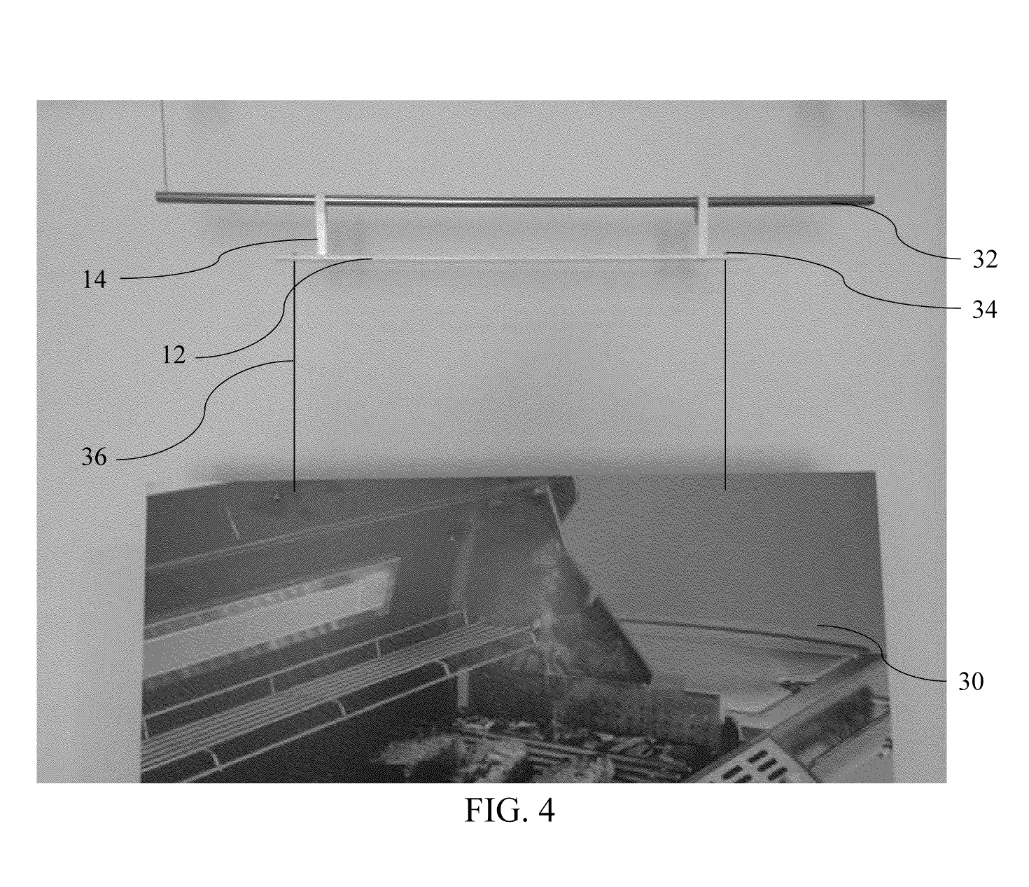

In an alternate embodiment of the present invention, a plurality of holes 34 may be disposed with the extension 12 instead of or in addition to the one or more attaching devices 20. A plurality of string, rope, chain, thread, or other tying material known to one skilled in the art 36 may be threaded through the plurality of holes 34 to hold or otherwise support the advertisement or good 30 as shown in FIG. 4.

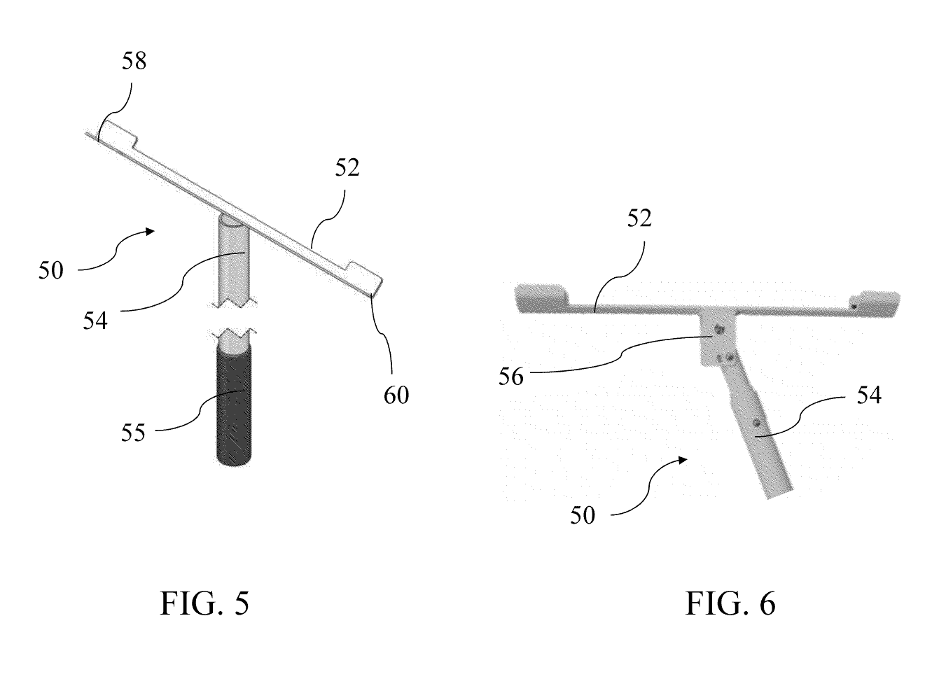

Additionally, a lifting pole 50, as shown in FIG. 5, may be used to direct and place the hanger apparatus 10 at a determined location. As discussed above, the location may be overhead or near overhead. The lifting pole 50 may allow a user to direct the hanger apparatus 10 to a location normally out of reach of the user. Of course, the hanger apparatus 10 may be placed at a location in reach of the user and on a surface such as a shelf or the floor. Additionally, the lifting pole 50 may be angled such that the user may place the hanger apparatus 10 over objects on the floor or in locations where the operator cannot stand directly below.

Specifically, the lifting pole 50 may comprise one or more receptacles 52 that may support the hanger apparatus 10 during placement. A user may direct the lifting pole 50 with a shaft 54 that may be connected to the one or more receptacles 52. The shaft 54 may end in a handle 55 that a user may use to maneuver the lifting pole 50. The one or more receptacles 52 may have a “V” shape or “U” shape cross-section and may allow the extension 12 to be temporarily disposed therein during placement. The one or more receptacles 52 may be wider on a first end 58 and a second end 60 as shown in FIGS. 5-7 to better hold the hanger apparatus 10 therein. Of course, the one or more receptacles 52 may be any shape known to those skilled in the art that would support the present invention during placement.

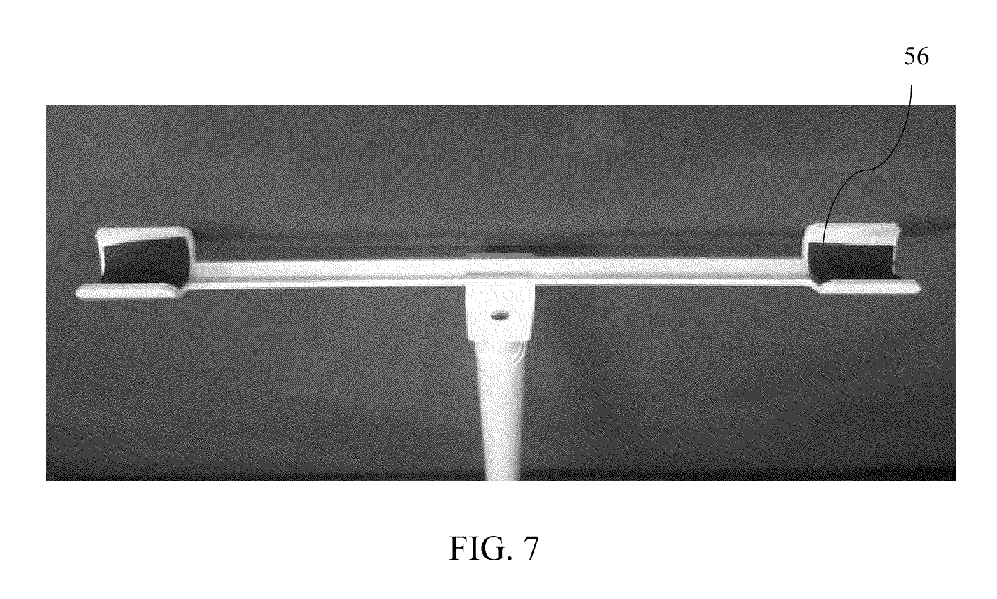

As shown in FIG. 6, the one or more receptacles 52 may be pivotally connected to the shaft 54 at a pivot point 56, such that the lifting pole 50 may be used at multiple and differing angles. The pivot point 56 may allow rotation in a single direction or in multiple directions. In one embodiment, the pivot point 56 may be a ball and socket joint and may allow rotation in three dimensions. In another embodiment, the pivot point 56 may be a hinge joint and may allow rotation in a single plane. Specifically, the one or more receptacles 52 may remain level while the shaft 54 is angled and adjusted by the user. The user may therefore manipulate the lifting pole in a number of directions easily and without dropping the hanging apparatus 10 temporarily disposed within the one or more receptacles 52. Additionally, the one or more receptacles 52 may be surrounded with gel, rubber, foam, or other high friction material 62, as shown in FIG. 7, to prevent the hanger apparatus 10 from moving during placement.

In one embodiment, one or more advertisements or goods 30 may be attached to the one or more attaching devices 20 prior to placement. Then the hanger apparatus 10 may be supported by the one or more receptacles 52 on the lifting pole 50. The one or more securing devices 14 and/or the extension 12 may freely rotate therein, likely falling downwardly due to gravity. Alternatively, the extension 12 and/or the one or more securing devices 14 may be held in place with the gel, rubber, foam, or other high friction material 62 that may be disposed within the one or more receptacles 52. The user may then lift the lifting pole 50, hanger apparatus 10, and the one or more advertisements or goods 30 together to a desired location. The user may lift the hanger apparatus 10 above an object or structure, similar to the object 32 shown in FIGS. 3-4, at the desired location and may bring the hanger apparatus 10 downwardly until the one or more securing devices 14 surround, hang from, or are otherwise supported by the object or structure at the desired location. The user may then remove the lifting pole from the hanger apparatus 10 and the hanger apparatus 10 and the one or more advertisements or goods may hang freely. The user may use the lifting pole 50 to adjust the one or more attaching devices 20 such that the one or more advertisements or goods are displayed as desired. For example, the lifting pole 50 may be used to move the one or more attaching devices 20 left and/or right along the extension 12 such that the advertisements or goods are not bunched together or otherwise disrupted from view.

The one or more advertisements or goods may be level so long as the object the hanger apparatus 10 hangs from is also level. Of course, the one or more securing devices 14 and the one or more attaching devices 20 may have differing lengths in order to compensate for non-level objects or structures.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

1. An apparatus comprising:
a level extension with at least one securing device disposed thereon, wherein the at least one securing device is capable of being hung at a near overhead location; and
at least one attaching device disposed on the level extension, wherein the at least one attaching device is capable of receiving objects to be hung thereon.

2. A system comprising:
a extension;
at least one securing device disposable on the extension, wherein the at least one securing device is capable of being hung at a near overhead location;
at least one attaching device disposable on the extension, wherein the at least one attaching device is capable of receiving objects to be hung thereon; and
a lifting pole, wherein the lifting pole is used to hang the extension at a near overhead location.

3. A method comprising the steps of:
providing an apparatus comprising a level extension with at least one securing device disposed thereon;
hanging the at least one securing device over an object;
positioning at least one attaching device on the level extension; and
hanging an advertisement or good on the at least one attaching device.
